(19) United States
(12) Patent Application Publication
(10) Pub. No.: US 2010/0010888 A1
(43) Pub. Date: Jan. 14, 2010

(54) METHODS AND SYSTEMS FOR OFFERING PURCHASE INCENTIVES

(76) Inventor: Richard Maertz, Laguna Hills, CA (US)

Correspondence Address: Luce, Forward, Hamilton & Scripps LLP, 2050 Main Street, Suite 600, Irvine, CA, 92614, US

(21) Appl. No.: 12/172,414

(22) Filed: Jul. 14, 2008

(51) Int. Cl. G06Q 20/00

(52) U.S. Cl. 705/14.18; 705/14.34

(57) ABSTRACT

One embodiment of the present invention advantageously provides rebates in association with purchases. These rebates are then automatically apportioned and distributed into various accounts, such as charitable and investment accounts, in accordance with the purchaser's directives.

### RELATED APPLICATION

This application claims the benefit of and priority to U.S. patent application Ser. No. 09/493,377, filed Jan. 28, 2000, the contents of which are incorporated by reference herein in its entirety.

### BACKGROUND

1. Field of the Invention

The present invention is related to systems and methods for providing purchase incentives, and more specifically, to methods and systems for distributing a portion of purchase proceeds to accounts associated with the purchaser.

2. Description of the Related Art

Retailers, credit card providers, and other merchants have expended great effort and expense is attempting to develop customer loyalty. For example, airlines offer frequent flyer miles, which entitles customers to free or upgraded service if they have flown a predetermined number of miles on the airline. Similarly, some credit companies have given cash rebates equal to a percentage of purchases made on the credit card.

These conventional techniques have had significant drawbacks. For example, they tend to be fairly restrictive and inflexible and, as is the case with most frequent flyer program. For example, frequent flier miles generally can only be used for travel related services, and often expire after a time set by the airline. With respect to credit card rebates, the rebates are often quickly spent and do not significantly affect the long term net worth of the customers. Therefore, long term customer loyalty is not significantly enhanced, and the goodwill associated with the rebates quickly dissipates.

### SUMMARY

One embodiment of the rebate system of the present invention advantageously provides and/or distributes rebates in association with purchases and distributes those purchases into various accounts in accordance with the purchaser's directives. The accounts may be charity related, or may be investment related. The rebates improve and maintain customer loyalty by providing long term savings and/or by allowing tax deductible charitable contributions to be made on the customer's behalf to customer selected charities.

For example, rebates may be automatically deposited into educational accounts, charitable accounts, accounts associated with schools, non-profit sports teams, and the like. Similarly, rebates may be automatically deposited into brokerage accounts, mutual funds, bank accounts, 401K accounts, IRA accounts, Roth IRA accounts, and so on. The customer can apportion how much of each rebate is to go into which account. The customer may also manage his or her account, change rebate allocations, and get updated account status via the Internet.

In addition, the rebate system may also be used as a conduit to provide other benefits to members. For example, the rebate system may be used to provide members with merchant or manufacturer coupons, discounts, or other special offers. Member buying patterns tracked by the rebate system may be used to build member profiles. These member profiles may then be used to better target the benefits and special offers to appropriate members.

Membership into the rebate program may be free or a fee may be charged. Further, free membership may automatically be offered and/or granted to certain qualifying individuals, such as those that receive affiliated credit cards, are members of certain organizations, or in conjunction with a purchase. In addition, certain qualifying individuals may receive special offers based to similar criteria.

### DRAWINGS

The above-mentioned features and objects of the present disclosure will become more apparent with reference to the following description taken in conjunction with the accompanying drawings wherein like reference numerals denote like elements and in which:

FIG. 1 illustrates an exemplary commerce system, including components for implementing a purchase incentive system in accordance with one embodiment of the invention;

FIG. 2 illustrates an exemplary Web-based form where users can specify how the want incentive portions of sales proceeds distributed;

FIG. 3 illustrates an exemplary Web-based page which provides an account report on a member's inventive distribution; and

FIG. 4 illustrates an exemplary sequence of acts that are performed by the purchase incentive module illustrated in FIG. 1.

### DETAILED DESCRIPTION

The present invention relates to an electronic system for distributing a portion of purchase proceeds to accounts associated with a purchaser. The proceeds may be in the form of a rebate or the like. The rebates improve customer loyalty by benefiting the customer. In accordance with one embodiment of the invention, the system provides customer rebates which may be automatically deposited into designated accounts, including investment accounts, fund raising accounts, educational accounts, charitable accounts, accounts associated with schools, non-profit sports teams and the like. The rebates collection and distribution process may be managed by a rebate management provider.

For example, a customer may be offered a 3% rebate or a flat dollar amount rebate on each purchase made from or using the services of rebate incentive participants or partners. The partners may be merchants, financing institutions, such as credit card or loan companies, insurance companies, and the like, that are associated with the rebate program. The merchant may be an on-line merchant, or a conventional store located in a mall. The size and /or type of the rebates may be selected by the partners or may be selected and/or provided by the rebate management provider. Participants may be located within the United States or elsewhere. In addition, the rebate system may be used as a conduit or to distribute rebates provided by others, such as manufacturer rebates, merchant special discounts, excess inventory related discounts and so on.

One novel aspect to one embodiment of present invention is that the customer may select, via an on-line form or the like, how the rebate is to be distributed. For example, the customer may designate different portions of each rebate to be allocated to different accounts. Thus, the customer may designate that half of each rebate is to go to a particular charity, and that half of each rebate is to go into an investment or bank account associated with the customer. The customer may also elect to have all or part of rebates to be placed in an interest bearing holding account managed by the rebate management provider. The customer may then later decide how to allocate all or portions of the rebates in the holding account. The holding account may be an interest bearing bank escrow account, money market fund, mutual fund, or the like.

Because the customer receives valuable rebates which may be automatically distributed to multiple accounts, the customer will be very motivated to shop at merchants or to use credit cards associated with the rebate program. Hence, the merchants and/or credit card companies will likewise have an incentive to join and maintain participation in the rebate incentive program.

In one embodiment, customers can join the incentive program for free. Customers may join both at a conventional merchant location, via an on-line World Wide Web site, by mail, and/or by telephone. For example, if a customer is making a purchase at a merchant associated with the rebate incentive program, the customer may be immediately offered the opportunity to join the program and receive a rebate on the purchase being made. If the customer agrees to join while shopping at a conventional merchant establishment, the customer may be given a conventional, physical, form to fill out. If the customer agrees to join while shopping at an electronic or Internet merchant, the customer may be presented with an electronic form to fill out. In addition, a customer may navigate directly to a Web site, or the like, associated with the rebate incentive program, and join via a form presented at the incentive program website. The website may list participating merchants, as so to further encourage people to join and to encourage shopping at the participating merchants. Of course, other methods of enrolling may be used as well, such as by providing information verbally to a human operator or electronic operator during a purchase being made over the phone, or via a computer kiosk at a merchant location.

The form may include fields in which the customer can enter such customer information as name, physical address, e-mail address, phone number, social security number, credit card accounts, investment accounts, bank accounts, desired personal identification number (PIN) and the like. In addition, the form may include fields in which the customer can specify how and to where the rebates are to be distributed. For example, the customer can designate one or more charities to be recipients of portions of the rebates.

The designated portions may be specified as a percentage of the rebates. In addition, in one embodiment, the customer may specify that a first dollar amount, such as $100, is to go to the first specified charity and that the next $150 is to go to the next specified charity, and so on. The charities may include conventional charities, such as the United Way, religious organizations, non-profit educational institutions, scholarship funds, art institutions, and the like. A customers can also designate portions of the rebate to go to little league teams, clubs, political causes, and so on. In one embodiment, the customer may designate how often or on which date rebates are to be transferred to the recipients. In another embodiment, the rebates are automatically transferred on a periodic bases, such as monthly, weekly, or daily.

In addition to charities, customers can specify that portions of the rebates are to go into investment accounts or towards financial instruments. The accounts may be accounts of the customer which existing prior to utilizing the rebate incentive program. The investment accounts may include, but are not limited to, new or existing brokerage accounts, mutual funds, insurance accounts, bank accounts, 401K accounts, IRA accounts, Roth IRA accounts, other tax free accounts, and so on. The rebate incentive operator may optionally maintain investment accounts directly.

Once the rebates are collected, the rebate incentive system will automatically and electronically transfer funds associated with the rebates to the designated recipients as specified by the customer.

The rebate incentive system may define certain market segments. For example, clothing retailers, credit card services, supermarkets, gas stations, drug stores, and airlines, may be designated as corresponding market segments. The rebate incentive system may optionally offer exclusive partnering relationships within each of these market segments. For example, only one airline may be allowed to participate in the rebate incentive program, making the program more valuable to the one airline that is allowed to participate. Of course, if desired, multiple partners may be allowed to participate within a market segment. Furthermore, different market segments, and indeed, different companies within a market segment, may optionally offer corresponding different levels of rebates.

In one embodiment, each partnering merchant or participant pays an initial, yearly, and/or periodic fee, to the rebate incentive company to join the rebate incentive program. In addition, partners may optionally be required to pay a portion of each sale or a portion of the gross sales to the rebate incentive company as a royalty. Of course, in other embodiments, partners may be allowed to join for free, or in exchange or partly in exchange for other consideration, such as advertising at the partner's stores, websites, or in conjunction with mailings, radio advertisements, television advertisements, print advertising, and so on.

Similarly, customers may be allowed to join for free, or for a yearly or periodic fee. In another embodiment, some customers may be charged a fee to join, while others, such as those holding certain credit cards, such as VISA, or belonging to a particular wholesale club, professional organization, union, credit union, religious organization, or who are employees of certain companies, may be allowed to join for free or for a reduced fee. Membership in the rebate incentive program may be automatically provided on top of the membership in any of the groups mentioned above.

Membership identification may be provided as a unique identifier on the face of a credit card issued by a participating financial institution, or on the face of a card issued by other participating companies or institutions. In addition or in the alternative, the member identifier may be encoded on a magnetic strip on the back of the cards or via a bar code on the cards. For on-line purchases, the identification information can be stored in a cookie or the like. The membership identification may also be manually entered. Of course, other techniques for recording identifiers, such as holograms, fingerprints, voice prints, retina prints, and the like may be used as well. The identifier may also be further encrypted to better protect the members privacy and account. The unique identifier may be included as part of purchase orders when a card is not used as part of the purchase transaction. Thus, for example, the identifier may be included as part of the purchase Order for the purchase of cars, real estate, loans, and so on.

One advantage of the present system is that customers may examine and/or edit their account using a terminal or phone to access the Internet or the like, from anywhere in the world, 24 hour a day, 7 days a week. A secure PIN number, either selected by the customer when registering, or generated by the rebate incentive program operator, is used by the customer to gain access to their account.

When a customer visits a partnering institution an insignia, text, identifier, or the like may be presented to the customer, indicating that the institution is an authorized partner. In addition, a customer may be notified as to which institutions, such as merchants, are participating in the rebate incentive program via e-mail sent to the customer's e-mail address. The e-mail may be sent directly by the rebate incentive program operator, or by the individual participating partner.

Advantageously, tax receipts for charitable contributions made via the rebate incentive program may be e-mailed or faxed to the customer. Further, in the event that the customer loses the receipts, the customer can request or download copies of the receipts. Thus, the customer always has access to accurate records and receipts, thereby ensuring that the customer will request and receive the proper state and/or federal tax deductions corresponding to the charitable contributions.

In addition, members, may establish special savings accounts for minors, such as children and grandchildren. When the minor makes purchases, the rebates associated with the purchases are deposited into the minor's account. Subject to certain rules established by the adult, primary member, the minor may withdraw or otherwise spend or invest the saved rebates. For example, the primary member may allow the minor to withdraw only a certain percentage or dollar amount per week or per month. Similarly, the primary member may not allow any withdrawals by the minor, until the minor reaches a certain age, such as 18. The minor may also be provided with her or his own rebate card for the purposes described above. Thus, these special accounts can advantageously help minors learn how to save and manage money.

Further, customers who are members of the rebate incentive program may be provided special offers, such as higher rebates on particular items or from particular merchants, special discounts, or coupons to be used in the future. Customers may be notified of these special offers via e-mail, banner ads on participating institution websites, flashing links, and the like. Special bonuses may be offered once a customer purchases from participating institutions or merchants have reached corresponding pre-designated levels. Similarly, special rebates or offers may be provided to members who have used or logged onto their accounts within a predetermined period, such as within the last month.

Optionally, portions of the rebates may be made available to customers via checks, credit card credits, coupons, discounts, or the like. The coupons may be electronic coupons with corresponding unique identifiers, downloadable coupons, or physical coupons mailed to the customer. The discounts may be in the form of an authorization code, which when entered at a Web site entitles the customer to an associated discount. Special rates for certain products, such as insurance, may be offered based on a group rate associated with the rebate membership. In addition, certain special offers may only be offered on certain items to selected members, based on their profile. Further, based on member profiles, selected members may be offered test market opportunities and may be paid a fee by the test market sponsor in return for filling out a questionnaire or otherwise evaluating the product or service being test marketed.

The member profile may include information such as a list of organizations with whom the member is associated, certain demographic criteria, including age, income level, gender, geographic locations, provided on their membership form or otherwise received, and/or buying pattern information gathered by the rebate incentive program operator. Thus, based on the member profiles, offers may be advantageously targeted to appropriate recipient's, rather than being randomly “spammed.” In one embodiment, customers can request that no special offers or advertisements be sent.

In addition, in one embodiment, a merchant profit sharing dividend is provided to members. In one embodiment, the dividend is only provided when yearly purchases at a corresponding affiliated merchant have reached a selected level or is provided proportionally based on the amount that have spent in a given year at corresponding affiliated merchants. The rebate management provider may optionally match all or a portion of the dividend provided by the merchant.

Merchants, service providers, and the like, who are making the special offers may be charged a fee or royalty to have the special offers transmitted by the rebate incentive program operator via e-mail or the like to the selected customers. In one embodiment, these merchants do not actually know the customers' identities, but are only provided certain demographic information. This helps maintain the privacy of the customers and the security of customer lists.

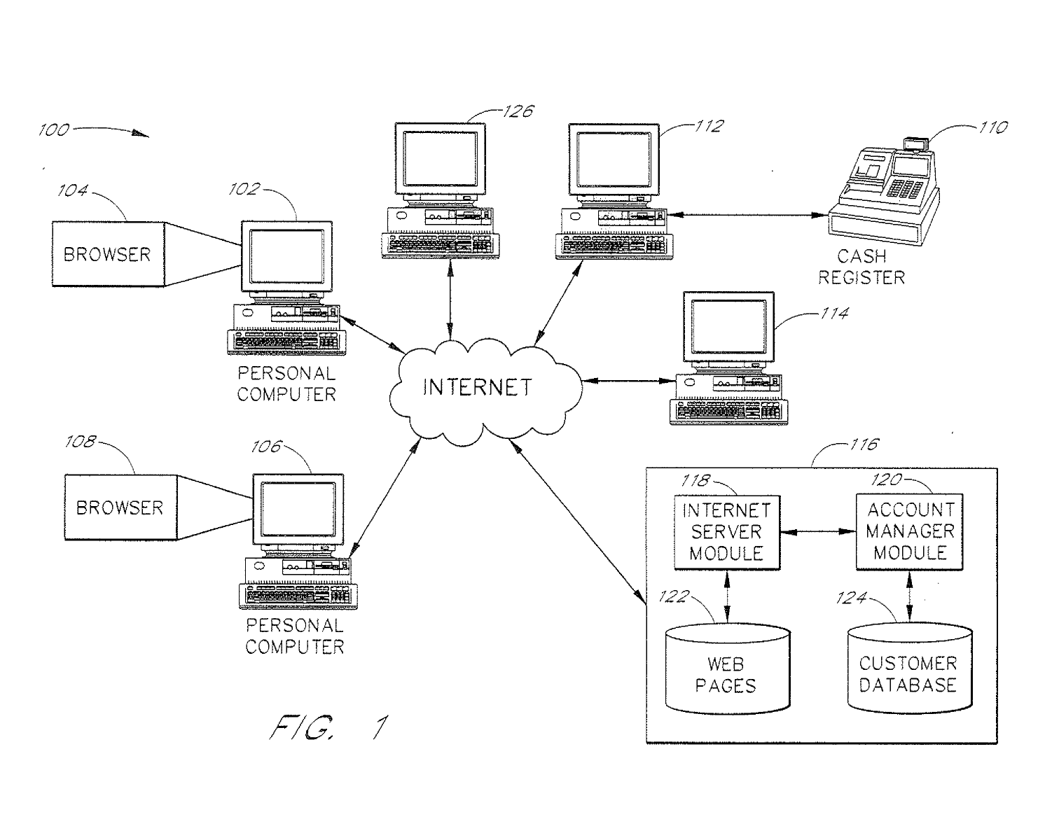

FIG. 1 illustrates exemplary basic hardware and software modules used to implement one embodiment of the rebate incentive system. As illustrated, customers may access the rebate incentive program Web site 116 using respective personal computers, 102, 106 or other terminals, such as phone and personal digital assistants, that have access to the Internet. The customer computers 102, 106 may run commercially-available Web browser applications 104, 108 such as Microsoft Internet Explorer®, which implements World Wide Web standards such as HTTP, HTML, XML and the like. The customer computers 102, 106 may also runs commercially available e-mail applications, such as Microsoft Outlook®, which may used to receive promotional information or account information from the Web site 116 or directly from merchant computer systems 112, 114.

Customers may make purchases from merchants by establishing links over the Internet or other network to merchant computers or servers 112, 114. The merchant computers or servers may be implemented using mainframe computers, minicomputers, personal computers, and so on. In addition to make purchases over a network, customers can make purchases in a physical store via a point-of-sale terminal or register 110 networked or otherwise coupled to the merchant computer 112. Information related to the purchase is relayed from the merchant computers 112, 114, to the rebate incentive program website 116 over the Internet, private network, or using other techniques for transferring digital data, such a magnetic tape. The information may be relayed in real-time, or periodically, such as once a day. In addition, the appropriate rebate funds may be transferred from the merchant to the company or institution managing the incentive system, who then, as described below, transfer the rebate to the appropriate accounts.

In illustrated embodiment, the website 116 includes a computer server system and software modules, as well as associated content accessible using the Internet. The website content may be distributed over several Internet domains, and may be implemented using several servers located at various locations. Of course, a variety of networks, both public and private, may be used as well.

The rebate incentive website 116 uses a commercially-available Internet server module 118 which accesses a database 122 that is used to store and/or dynamically generate Web pages in response to end user actions. The Web pages may be in the form of HTML pages.

The Web site 116 further comprises an account manager application module 120 (hereinafter, the “AM module”). The AM module 120 handles customer and merchant accounts so as to credit the customer accounts with the appropriate merchant rebates and apply those rebates as directed by the customer. The AM module 120 accesses a customer database 124 that stores the customer-related information discussed above, customer instructions as to how rebates are to be applied, whether the customer is a member of certain preferred groups, the merchants which the customer has frequented, the rebates received, credit information, and the customer account status.

In accordance with customer instructions, the AM module 120 electronically transfers rebates and related information to corresponding designated accounts by communicating with computer systems 126 associated with companies managing those accounts. For example, the computer system 126 may be associated with an investment institution, a charitable institution, an educational institution, and so on.

The rebate incentive program website 116 may also be networked to manufacturers, distributors, airlines, credit card companies, supermarkets, and like, who may provide rebates, points, such as frequent flier or purchase points, and discounts, including discount coupons. The frequent flier or purchase points may be used to obtain free or upgraded service, rental car, hotel and the like. The rebate incentive program website 116 may then be a conduit for all rebates and discounts up and down a product distribution channel. These rebates may be then handled and distributed in the same or a similar manner as the rebates discussed above. In one embodiment, non-cash rebates, such as frequent flier mile points, are not deposited in investment-type accounts. Instead, if allowed by the rebate provider, they may be deposited in non-cash accounts associated with charitable institutions or may, of course, be provided directly to the customer.

As previously discussed, customers may examine and/or edit their account using a terminal or phone to access their accounts stored in the customer database 124.

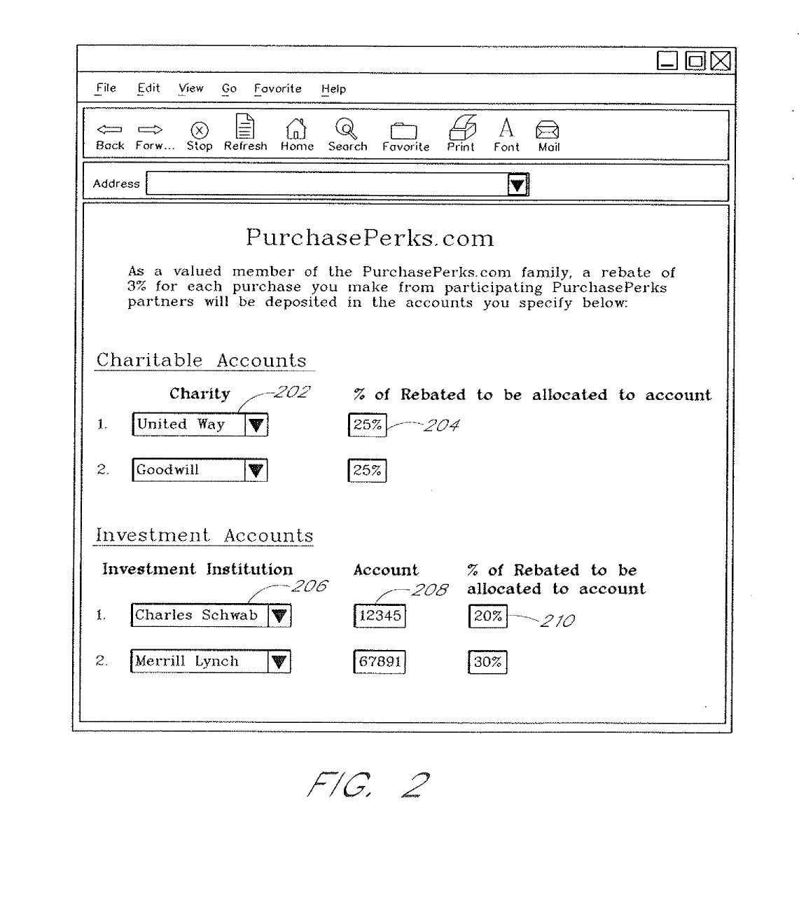

FIG. 2 illustrates an exemplary Web-based form where users can specify how they want incentive portions of sales proceeds distributed. In the illustrated example, a member customer can specify both charitable accounts and investment accounts. A drop-down menu field 202 may be provided from which the member customer can select from an authorized list of charitable recipients. In addition, a field (not shown) may be provided in which the member customer can type in the name of the charity as well as corresponding information, such as tax identification number, address, phone number, and so on. The allocation amount may be specified in an allocation field 204. In the present example, the customer member specifies the percent of the rebate to be allocated to the corresponding charity. While the form illustrated in FIG. 2 provides space for listing two charities, greater or fewer spaces may be provided.

Similarly, a drop-down menu field 206 may be provided from which the member customer can select from an authorized list of investment institutions. An account field 208 is provided for entering the appropriate account number. In addition, a field (not shown) may be provided in which the member customer can type in the name of the investment institution as well as corresponding information, such as account number, address, phone number, and so on. The allocation amount may be specified in an allocation field 210.

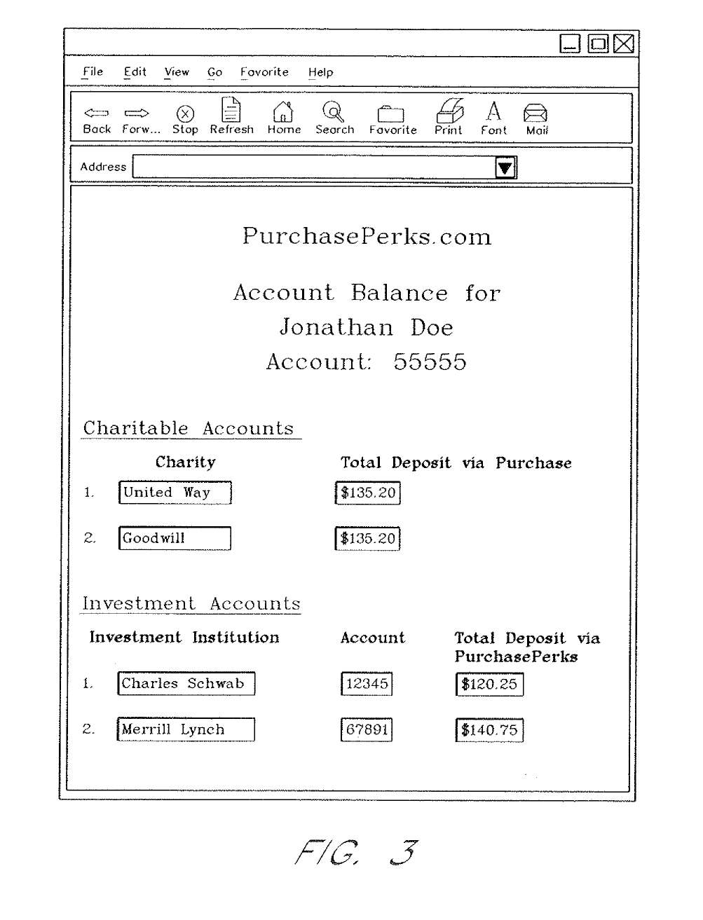

FIG. 3 illustrates an exemplary Web-based page which provides an account report on a member's incentive distribution. This report may be periodically be mailed, via regular mail or e-mail, to the member. In addition, the member can retrieve the account balance via the Internet. In the illustrated example, the total contributions made to various charitable institutions and investment accounts is reported. Further information, such as a yearly, monthly, weekly and/or daily breakdown of the deposits.

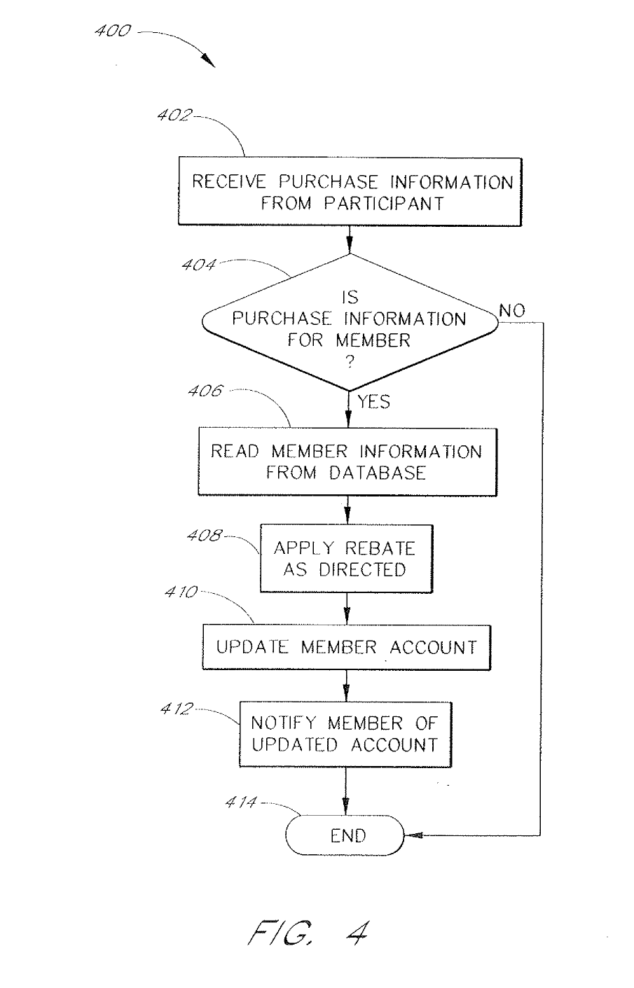

FIG. 4 illustrates an exemplary process 400, including a sequence of acts that are performed by the AM module to process and apply rebates associated with a purchase. This process 400 executes after the customer has made a purchase at a participating merchant or using an affiliated credit card. Beginning at state 402, information regarding the purchase is received from the participating merchant of credit card company. The information may include a customer identification, including a membership number, the amount of the purchase, and the items purchased. Proceeding to state 404, a determination is made as to whether the customer is indeed a member of the incentive program. If the customer is not a member, the process proceeds to the end state 414.

If the customer is a member, the process 400 proceeds to state 406, where the customers membership information and directives are read from the customer database 124 illustrated in FIG. 1. The rebate corresponding to the purchase is applied to account and charities in accordance the member's instructions, such as those which may be entered using the form illustrated in FIG. 2. The member's account is update in state 410 to reflect the latest rebates. Proceeding to state 412, the new account information may be provided to the member via e-mail or the like. The process 400 then proceeds to the end state 414.

As can be envisioned by a person skilled in the art, the rebate incentive program website may include an interface control system for a purchase award program to provide an apportionment of a dollar amount to at least two pre-tax accounts. The interface control system may include an interface unit for receiving an identifier transmitted during a purchase transaction, and for transmitting the apportionment of the dollar amount to the at least two pre-tax accounts. The identifier may be associated with a customer account in the purchase award program. The interface control system may also include a unit for verifying coupled to the interface unit for verifying a customer's membership in the purchase award program from the identifier received by the interface unit. Additionally, the interface control system may include a qualification unit coupled to the interface unit for controlling the selection of the at least two pre-tax accounts for apportionment of a dollar amount. The qualification may be based at least in part on participation of a pre-tax account provider with the purchase award program. The interface control system may further include a unit for storing a customer's directives for apportionment of the dollar amount to the at least two pre-tax accounts. Moreover, the interface control system may include a unit for processing coupled to the interface unit and the storing unit for processing the customer's directives for apportionment of the dollar amount to the at least two pre-tax accounts.

As can be appreciated, a system for a purchase award program is provided. The system may include a memory and a processor. The memory may be used to store a customer's selection of at least two accounts, and a customer's directives for apportionment of an award to the at least two accounts. The award may be associated with a purchase transaction and selected from a group consisting of a dollar amount, a rebate and a credit value. The processor may be configured to receive an identifier transmitted during the purchase transaction. The identifier may be associated with a customer account in the purchase award program. The processor may be further configured to verify a customer's membership in the purchase award program using the identifier, retrieve the customer's selection of the at least two accounts and the customer's directives for apportionment from the memory, and process the customer's directives for apportionment of the award to the at least two pre-tax accounts.

Furthermore, as can be appreciated by a person skilled in the art, a machine-readable medium is provided. The machine-readable medium provides instructions, which when read by a processor, cause the machine to perform operations that may include receiving electronic notification of a qualified purchase transaction associated with a customer account in a purchase award program, retrieving a customer's selection of a first and second account for apportionment of a purchase award, retrieving a customer's directives for apportionment of the purchase award, the customer's directive for the first account is an apportionment of the purchase award as a dollar amount, the customer's directive for the second account is an apportionment of the purchase award as a credit value, and processing the customer's directives for apportionment of the purchase award to the first and second account.

While the system, method and machine-readable medium for offering purchase incentives have been described in terms of what are presently considered to be the most practical and preferred embodiments, it is to be understood that the disclosure need not be limited to the disclosed embodiments. It should also be understood that a variety of changes may be made without departing from the essence of the invention. Such changes are also implicitly included in the description. They still fall within the scope of this disclosure. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

It should be understood that various modifications and similar arrangements are included within the spirit and scope of the claims, the scope of which should be accorded the broadest interpretation so as to encompass all such modifications and similar structures. The present disclosure includes any and all embodiments of the following claims.

1. An interface control system for a purchase award program to provide an apportionment of a dollar amount to at least two pre-tax accounts, the interface control system comprising:
interface means for receiving an identifier transmitted during a purchase transaction, and for transmitting the apportionment of the dollar amount to the at least two pre-tax accounts, the identifier being associated with a customer account in the purchase award program;
means for verifying coupled to the interface means for verifying a customer's membership in the purchase award program from the identifier received by the interface means;
qualification means coupled to the interface means for controlling the selection of the at least two pre-tax accounts for apportionment of a dollar amount, the qualification being based at least in part on participation of a pre-tax account provider with the purchase award program;
means for storing a customer's directives for apportionment of the dollar amount to the at least two pre-tax accounts; and
means for processing coupled to the interface means and the storing means for processing the customer's directives for apportionment of the dollar amount to the at least two pre-tax accounts.

2. The interface control system of claim 1, further comprising a means for depositing the dollar amount in the at least two pre-tax accounts in accordance with the customer's directives for apportionment.

3. The interface control system of claim 1, wherein the pre-tax account is selected from a group consisting of a 401k account, a Roth IRA account, a 529 Plan, a health savings account, and a flexible spending account.

4. The interface control system of claim 1, wherein the identifier is selected from a group consisting of a hologram, a fingerprint, a voice print, and a retina print.

5. The interface control system of claim 1, further comprising:
means for transferring frequent flier points to the customer account; and
means for depositing the dollar amount in the pre-tax account equivalent in value to the transferred frequent flier points.

6. The interface control system of claim 1, further comprising:
means for selecting coupled to the qualification means for selecting a charitable account from a list of qualified charitable account providers;
a memory for storing a customer's directives for apportionment of the dollar amount to the charitable account; and
a processor coupled to the interface means and the memory for processing the customer's directives for apportionment of the dollar amount to the charitable account.

7. The interface control system of claim 6, wherein the charitable account is selected from a group consisting of a non-profit organization account, a religious organization account, a non-profit educational institution account, a scholarship fund account, a donation account, a little league account and a political contribution account.

8. A system for a purchase award program, the system comprising:
a memory for storing a customer's selection of at least two accounts, and for storing a customer's directives for apportionment of an award to the at least two accounts, the award being associated with a purchase transaction and selected from a group consisting of a dollar amount, a rebate and a credit value; and
a processor configured to:
receive an identifier transmitted during the purchase transaction, the identifier being associated with a customer account in the purchase award program,
verify a customer's membership in the purchase award program using the identifier,
retrieve the customer's selection of the at least two accounts and the customer's directives for apportionment from the memory, and
process the customer's directives for apportionment of the award to the at least two accounts.

9. The system of claim 8, wherein one account of the at least two accounts has an apportionment of the award as a dollar amount and the second account of the at least two accounts has an apportionment of the award as a credit value.

10. The system of claim 8, wherein one account of the at least two accounts has an apportionment of the award as a dollar amount and the second account of the at least two accounts has an apportionment of the award as a rebate.

11. The system of claim 8, wherein one account of the at least two accounts has an apportionment of the award as a rebate and the second account of the at least two accounts has an apportionment of the award as a credit value.

12. The system of claim 8, wherein the processor is further configured to qualify the selection of the at least two accounts for apportionments based at least in part on participation of an account provider with the purchase award program.

13. The system of claim 8, wherein the processor is further configured to provide a tax receipt for recordkeeping.

14. The system of claim 8, wherein the award is a profit sharing dividend from a qualified merchant participating in the purchase award program.

15. A machine-readable medium that provides instructions, which when read by a processor, cause the machine to perform operations comprising:
receiving electronic notification of a qualified purchase transaction associated with a customer account in a purchase award program;
retrieving a customer's selection of a first and second account for apportionment of a purchase award;
retrieving a customer's directives for apportionment of the purchase award, the customer's directive for the first account is an apportionment of the purchase award as a dollar amount, the customer's directive for the second account is an apportionment of the purchase award as a credit value; and
processing the customer's directives for apportionment of the purchase award to the first and second account.

16. The machine-readable medium of claim 15, wherein the dollar amount is a profit sharing dividend from a qualified merchant participating in the purchase award program.

17. The machine-readable medium of claim 15, wherein the customer's directive for the first account specifies a percentage of the qualified purchase transaction as the dollar amount.

18. The machine-readable medium of claim 15, wherein the first account is selected from a group consisting of an investment account, an escrow account, a fund raising account, an educational account, a charitable account, a bank account, an insurance account, a mutual fund account, and a credit card account.

19. The machine-readable medium of claim 15, wherein the second account is selected from a group consisting of a frequent flyer account, a credit card account and a loyalty program account.

20. The machine-readable medium of claim 15, further comprising depositing in the first account the dollar amount and crediting the second account with the credit value in accordance with the customer's directives for apportionment.
